(19) United States
(12) Patent Application Publication
(10) Pub. No.: US 2014/0046723 A1
(43) Pub. Date: Feb. 13, 2014

(54) SYSTEMS AND METHODS OF PROVIDING A MARKETPLACE FOR DISTRIBUTING LEADS

(71) Applicants: Erin Cheetham Clark, North Hampton, NH (US); Sunil Suresh Kini, Sharon, MA (US); Philip Joseph Peterlin, Wells, ME (US)

(72) Inventors: Erin Cheetham Clark, North Hampton, NH (US); Sunil Suresh Kini, Sharon, MA (US); Philip Joseph Peterlin, Wells, ME (US)

(21) Appl. No.: 13/834,537

(22) Filed: Mar. 15, 2013

Related U.S. Application Data
(60) Provisional application No. 61/682,372, filed on Aug. 13, 2012.

(51) Int. Cl. G06Q 30/02

(52) U.S. Cl. CPC G06Q 30/0201
USPC 705/7.29

(57) ABSTRACT

Systems and method of providing a web-based marketplace for distributing leads to a network of agents are provided. A method includes receiving data indicative of user identification and user insurance coverage from a plurality of website users, identifying a subset of the plurality of website users that fail to purchase insurance, generating a database that stores the data received from the subset of website users, and generating a price for purchasing the data received from each of the subset of website users. The price is added to the respective website user's data in the database. The method includes transmitting a portion of the database including the price to a third party, and receiving a request to purchase a first website user's data.

### CROSS-REFERENCE TO RELATED APPLICATIONS

This application claims the benefit of U.S. Provisional Patent Application No. 61/682,372 entitled “Systems and Methods of Providing a Marketplace for Distributing Leads” filed on Aug. 13, 2012, the entire disclosure of which is hereby incorporated by reference as if set forth herein in its entirety.

### BACKGROUND

People interested in purchasing insurance often begin by searching on the internet. During an internet search, users may view websites that allow them to input personal information to obtain an insurance cost quote. The purpose of the website usually is to sell an insurance policy to the website user, by providing a rate quote and opportunity to buy, or collecting contact information for follow up sales calls. However, many website users use the internet to find possible purchase options early in the process, sometimes with multiple stops at a site, but ultimately leave the website without purchasing an insurance policy. The reasons for not making the purchase can vary, but often the price and coverage do not meet the person's requirements. Despite the decision to not purchase insurance, data about the person and his or her inquiry can be valuable to insurance agents, who can potentially use the user data to connect with the user and present other insurance packages and pricing. The user data may include personal information entered by a user to an insurance website. Additionally, the user has invested time to provide the data and would benefit from receiving other insurance packages and pricing with no additional investment of time. However, currently available tools do not practically allow the user to connect with local agents, who may be able to offer other insurance policies from multiple companies. For example, local agents may be able to offer users policies from smaller insurance companies, which may be able to offer suitable insurance pricing and policies that would be desirable to the website users. In addition, current available tools most often require the website user to have several additional one-on-one conversations with different insurance agents that each represent a single company to compare insurance packages and pricing. However, consumers preferred method to buy insurance is through a single agent. Additionally, consumers prefer a single agent over a call center. A local independent agent represents multiple companies and can save the user time and help select the best fit. Improved products and services are needed to help introduce website users to insurance agents that can offer suitable policies, save them time, and provide independent advice.

Additionally, current sales platforms for selling leads to insurance agents send agents all leads that match selected criteria as soon as the lead is received. Thus, local agents are frequently charged for leads they are unable to pursue, for example, while they are providing service to others. Current sales platforms are also non-exclusive, sending leads to multiple lead buyers simultaneously, causing agents to rush to be the first agent to contact a lead, since the lead is most likely to use the agent who contacts them first. Local agents (without a large staff, call center or auto dialer technology of larger company lead buyers) are frequently charged for leads that another insurance agent has already locked down. Non-exclusivity also results in the website user being bombarded with calls from multiple agents. Improved products and services are needed to allow insurance agents to select and purchase only leads agents would like to pursue, and to prevent website users from being inundated with unwanted phone calls.

### SUMMARY

Systems and methods for providing a marketplace for distributing leads to a network of agents are provided herein. The information is collected from insurance websites, such as websites which allow users to enter information in order to receive an insurance quote. The information, such as personal information and preferences in regard to policy coverage and pricing, collected from a user is entered into a database and some portion of the information is displayed to insurance agents in the online marketplace. The online marketplace allows an insurance agent to choose to purchase further information about a particular user based on the displayed portion of the information. Once an agent purchases the information for a particular user (or purchases a “lead”), that user's information is removed from the online marketplace. Thus, the user's information becomes an exclusive lead for the agent who purchased it.

In one aspect, the methods include receiving, at an insurance quote server, data indicative of user identification and user-desired insurance coverage from a plurality of website users, and receiving, at the insurance quote server, a first input signal indicative of a request for an insurance cost quote from each of the plurality of website users. The insurance quote server transmits a first output indicative of an insurance cost quote in response to the first input signal. A first processor identifies a subset of the plurality of website users that fail to purchase insurance after the first output is sent and generates a database that stores the user identification and other data received from each of the subset of website users. An analyzer processor generates a first output signal for each of the non-purchasing subset of website users, wherein the first output signals are indicative of a respective price at which an agent (or other purchaser) can purchase the data received from each of the subset of website users. The first processor adds the price for purchasing the user data to the respective website user's data in the database. A second output signal representing a portion of the database is transmitted to a third party processor. The third party processor may display the portion of the database to an insurance agent, who may decide to purchase all of the website user's data (a lead), in order to contact the website user and attempt to sell the website user an insurance policy. If a user (e.g., an insurance agent) at the third party processor decides to purchase a lead, the third party processor sends the purchase request to the first processor. A third output signal representing a request to purchase a first website user's data is received from the third party processor, wherein the first website user is one of the subset of website users.

In one embodiment, the method includes transmitting, from the first processor to the third party processor, a fourth output signal representing the first website user's data, and removing, from the database, the data received from the first website user, and the price for purchasing the first website user's data. According to other embodiments, the method includes a step of updating the price for purchasing a second website user's data after the second website user's data has been listed in the marketplace for a predetermined period of time. In a further embodiment, the method comprises receiving a second input signal from each of the subset of the plurality of website users, the signal indicative of a willingness of the users to be contacted by an insurance agent. The user may want to be contacted by an insurance agent for consideration of alternative policies, or policies offered by other insurance providers from a single independent source. In some examples, a user may prefer purchasing insurance through an agent (as opposed to purchasing insurance online), since an agent can offer personalized service, answer questions and customize options according to the user's concerns.

In certain implementations, the price to purchase a user's data varies from user to user depending on several different factors. In one embodiment, a first price for purchasing the first website user's data is different than a second price for purchasing a second website user's data. The price for purchasing the data received from each website user of the subset may be generated based in part on a quantity of data provided by each respective website user. The price for purchasing the data received from each website user of the subset may be generated based in part on a quality of data provided by each respective website user. Quality may be determined by the type of information provided or by an analysis of the information itself. In one embodiment, the data received at the insurance policy server includes at least one of the town of residence, zip code, number of cars, driving record and phone number of each of the subset of website users. According to one embodiment, the price for purchasing the data received from each website user of the subset is generated based in part on a driving history of each respective website user.

According to certain implementations, the method includes acquiring a driving record for each of the subset of website users from a government motor vehicle registry, and the price for purchasing the data received from each of the subset of website users is generated based in part on the driving record for each of the subset of website users. Acquiring the driving record may include accessing an online copy of the driving record and downloading driving record data. The method may also include acquiring vehicle information for a vehicle owned by the first website user from a government motor vehicle registry, and where the price for purchasing the first website user's data is generated based in part on the vehicle information.

In certain implementations, the systems and methods include a website that allows website users to receive multiple insurance company quotes in a single website interaction. For example, a website may be configured so the user may enter personal information one time in order to receive multiple insurance cost quotes, and be able to purchase a policy from any of the companies through a single agent interaction.

According to certain implementations, the price of a website users data (i.e., the price of a lead) is updated depending on supply and demand. For example, if there are a lot of available leads, the price for each lead would decrease. Alternatively, if there are only a few available leads, the price for each lead may increase. According to another embodiment, the price of a particular lead may decrease over time. For example, after a lead has been on the market for an hour, it's price may decrease. In other examples, the price of a lead may decrease after the lead has been on the market for twelve hours or for one day. In one embodiment, the duration of time before a lead price decreases may depend on the time of day the lead was first posted. For example, if the lead was posted at night or over the weekend, the price may not decrease until after the next business day.

According to other applications, the systems and methods provide a secure environment for sharing personal information, such as personal insurance information. The secure environment may be a secure website. In one example the secure website uses the Secure Sockets Layer (SSL) protocol. According to certain applications, when a website user enters personal data, a formatted file of data is created for that website user, and the formatted file can be transported to a third-party comparative rater. The third party comparative rater may use the data in the formatted file to provide insurance quotes from several insurance providers, and provide the quotes to the user, allowing a user to compare the various quotes. In one example, systems and methods are provided to pass exclusive quote data to a comparative rater without double entry. According to one implementation, an authorized insurance agent can access a marketplace of leads, each including website users' information, by logging in to a secure website.

After an insurance agent purchases a lead (a website user's data), systems and methods are provided for the insurance agent to dispute the lead online, if the insurance agent believes the information provided by the lead to be false. According to another embodiment, systems and methods are provided for invoicing and storing a purchase history for each insurance agent in the network of insurance agents. In one example, an agent receives a periodic bill for the leads purchased. In another example, an agent's lead purchases are totaled at the end of a work cycle, and the total cost of the lead purchases is deducted from the agent's paycheck. Credits and debit adjustments can be made to the balances. In one embodiment, an agent may be prevented from purchasing more leads until a balance due is paid.

In one implementation, lead buyers (e.g., insurance agents) can elect to be notified when desired leads enter the marketplace. Each lead buyer may indicate certain criteria that a lead should meet in order to be sent a notification of the lead. For example, lead buyers may elect to be notified when a lead with a specific zip code enters the marketplace. According to one embodiment, systems and methods are provided for tracking, consolidating and sharing benchmarks of sales performance on purchased leads.

According to one aspect, a computer-implemented method of providing a web-based marketplace for distributing leads to a network of agents includes receiving, at an insurance quote server, data indicative of user identification and user insurance coverage from a plurality of website users, identifying, by a first processor, a subset of the plurality of website users that fail to purchase insurance, and generating, by the first processor, a database that stores the data received from the subset of website users. The method also includes generating, by an analyzer, a first output signal indicative of a proposed price for purchasing the data received from each of the subset of website users, wherein the proposed price is based on a base value, parameters entered by each of the subset of users, additive factors for each of the subset of users, subtractive factors for each of the subset of users, and a source factor to distinguish leads from different sources or sourcing methods. The first processor adds the proposed price for purchasing the data received from each of the subset of website users to the respective website user's data in the database. A second output signal representing a portion of the database including the proposed price is transmitted to a third party processor, and a third output signal representing a request to purchase the data entered by a first website user of the subset of users is received receiving from the third party processor.

### BRIEF DESCRIPTION OF THE FIGURES

The above and other advantages of the disclosure will be apparent upon consideration of the following detailed description, taken in conjunction with the accompanying drawings, in which like reference characters refer to like parts throughout, and in which:

FIG. 1 shows an example of a web page showing car insurance coverage rates for three different levels of insurance;

FIG. 2 shows a webpage for an online marketplace of leads, according to one implementation;

FIG. 3A shows an example of a webpage including more information about a selected lead;

FIG. 3B shows an example of a webpage for confirming a lead purchase request;

FIG. 4 shows a webpage of leads purchased by an agent, according to one implementation;

FIGS. 5A-5B shows a webpage of leads purchased by an agency, according to one implementation;

FIG. 6 shows an example of a webpage including a text edit box for submitting comments regarding the status of a lead;

FIG. 7 is a flowchart of a method for providing a web-based marketplace for distributing leads to a network of agents, according to one embodiment;

FIG. 8 is a block diagram of a system for dynamically pricing leads, according to one embodiment;

FIG. 9 is a flowchart of a method for providing a web-based marketplace for distributing leads to a network of agents, according to one embodiment; and

FIG. 10 is a block diagram of a system for providing a web-based marketplace for distributing leads to a network of agents, according to one embodiment.

### DETAILED DESCRIPTION

Systems and methods are provided for collecting information about insurance needs and preferences from website users and more efficiently aligning such users with available insurance products in a manner that allows purchasers to find insurance products that are suitable to the person's needs and budget. The information is collected from insurance websites, such as websites which allow users to enter information in order to receive an insurance quote. The information collected from a user is entered into a database, and some portion of the information is displayed to insurance agents in an online marketplace. The online marketplace allows an insurance agent to choose to purchase further information about a particular user based on the displayed portion of the information. The online marketplace presents the collected information to insurance agents that may have suitable products for the user but may not otherwise meet the user. Once an agent purchases the information for a particular user (or purchases a “lead”), that user's information is removed from the online marketplace. Thus, the user's information is an exclusive lead for the agent who purchased it.

By providing the online marketplace of leads to insurance agents, an agent is able to select and purchase the leads that the agent would like to pursue. In contrast, previous lead sales agencies and services send insurance agents all leads that match certain agent-selected criteria. According to one feature, insurance agents can save money by only purchasing leads the agents plans to pursue. Additionally, by allowing agents to purchase exclusive leads, agents have flexibility to pursue a purchased lead at any time. In contrast, when leads are sold to multiple agents, the agents race to be the first agent to contact a lead, since the lead is most likely to use the agent who contacts them first. Furthermore, since the leads are sold exclusively to one agent through the online marketplace, users who are interested in purchasing insurance are contacted by just one agent that represents multiple insurance companies and are not bombarded by multiple calls from multiple different insurance agents.

According to another advantage, providing the online marketplace of leads to insurance agents allows them to compete for leads with large insurance companies. Using previous lead sales agencies and services, large insurance companies almost always reached a prospective lead first by using auto-dialers and concierge services. Usually, the first agency to reach the lead secures the lead. Small, local businesses can not economically compete for the non-exclusive leads with the large companies. Consumers prefer to work with an agent, but it is unlikely that a consumer reaches an agent but by shopping online. Through true exclusivity, an agent can practically connect with the consumer and provide them choice and independent advice.

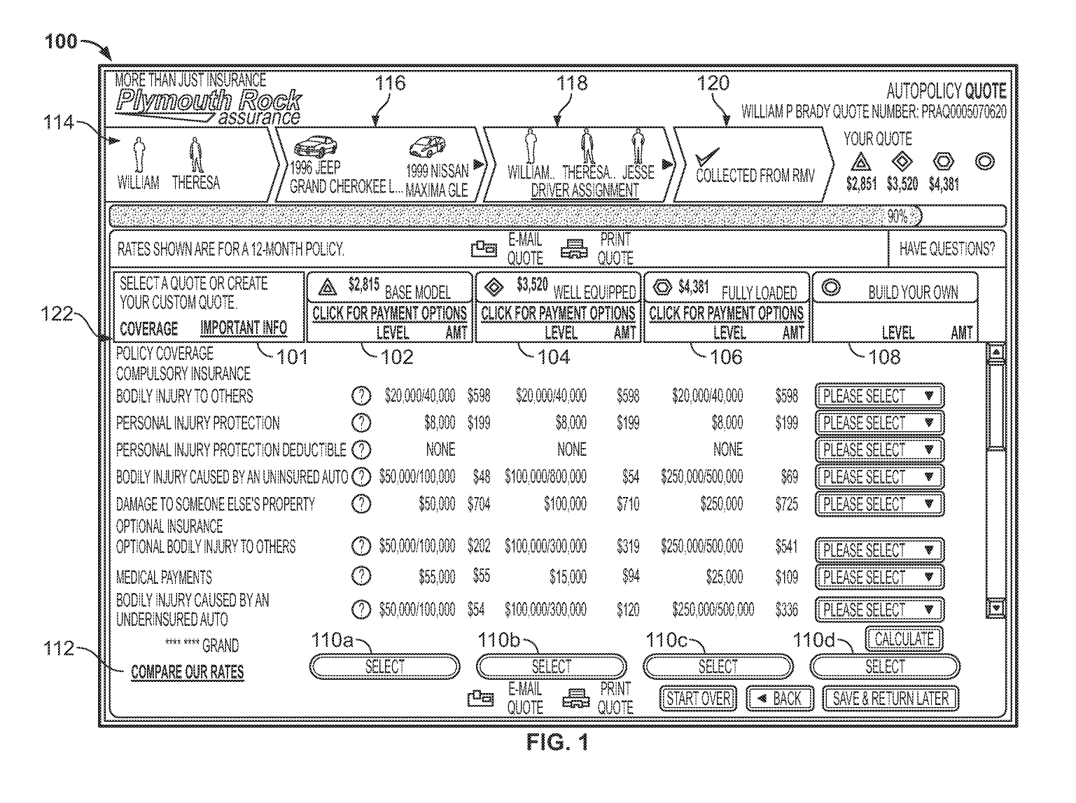

FIG. 1 shows an example of a webpage 100 showing car insurance coverage rates for three different levels of insurance. The webpage 100 of FIG. 1 is displayed to a user after the user has entered personal information to the website and requested a quote. In particular, the website server uses personal information provided by the user to generate the insurance quotes shown on the webpage 100 of FIG. 1. The webpage 100 shows three different insurance coverage rates. In particular, in the table 122, the first column 101 lists the various coverage options, such as “Bodily Injury to Others,” “Personal Injury Protection,” and “Medical Payments”.” The first coverage rate is shown in the second column 102 of the table and is least expensive. The second column 102 also shows the amount of coverage provided for different coverage options under this insurance policy. The second coverage rate is shown in the third column 104 and provides intermediate coverage as shown in the coverage amounts in the third column 104. The fourth column 106 shows the rate for premium insurance, which provides a higher level of coverage for various coverage options, but is also more expensive. A user may build their own insurance policy by selecting the coverage level for each category of insurance coverage, as shown in the fifth column 108. After a user has reviewed the various options and has chosen a coverage amount the user may then indicate their insurance selection using one of the tabs 110A, 110B, 110C or 110D at the bottom of the webpage 100. The user may also choose not to make any selection.

According to one implementation, the webpage 100 may show only one coverage rate. In another implementation, the webpage 100 shows two coverage rates. In a further implementation, each column 102, 104 and 106 shows a total coverage rate, and the various coverage options are not shown separately.

According to certain implementations, to provide the coverage quotes shown on the webpage 100, the website first collects information from the user requesting the quote. As shown as the top of the webpage 100, the user has entered information regarding the prospective owners 114 of the insurance policy, the cars 116 to be insured, and the people 118 to be insured. The website checks the Registry of Motor Vehicles (RMV) for records 120 on the cars 116 and the people 118 to be insured. The website also requests information from non-government third party services, such as LexisNexis. For example, the website may request a vehicle's Vehicle Identification Number (VIN) from a third party service. The quotes 102, 104 and 106 are generated by a website provider's processor and are based on the personal information entered by the user, any information returned from the RMV, and any information returned from a third party service.

In some implementations, a user may select the “Compare our Rates” button 112 shown in the bottom left hand corner of the webpage 100. If the user makes this selection, the website will display an offer to receive comparison rates from an agent, without re-entering user data. The user may select an “OK” button to accept the offer, thereby agreeing to be contacted by an independent insurance agent who can provide the user with quotes from other insurance companies. In some illustrative applications, the user may navigate away from the webpage or may save the information in case the user decides to return to the website later. In various applications, the “Compare our Rates” button 112 may be placed in any position on the webpage 100, on any insurance quote webpage, email, text or other digital media.

If the user navigates away from the webpage 100 or from one of the linked insurance-purchase websites without purchasing an insurance policy, the user's information is saved in a general database. The users in the general database are filtered, and those users who have provided a threshold amount of information are entered into a database of leads. To filter the users, a filter may apply various criteria based on the quality and quantity of information each user provided, and determine which users are entered into the database of leads. The database of leads may further distinguish between users who asked to be contacted by an independent insurance agent and those who navigated away from the website without purchasing insurance. The cost of a lead for a user who has asked to be contacted by an independent agent may be more expensive than the cost of a lead by a user who is simply navigated away from the website.

According to one implementation, a user is entered in the lead database when the user is presented with a rate quote and opts to be contacted by an agent. A user is also entered in the lead database when the user is presented with a rate quote, does not select the “purchase” button to purchase the quoted policy, and does not select out to be contacted by an agent. In another implementation, an algorithm predicts which leads are likely to buy direct from the initial insurance quote website, and these leads are filtered out of the marketplace. This allows the insurance quote website to maintain ownership of certain leads.

In a further implementation, the insurance quote website may source leads from one or more third party sites that also prospect for insurance shoppers online. Third party leads are validated and/or scored for quality (for example, the integrity of phone number or email address) before being entered in the lead marketplace. Low quality third party leads are rejected and not entered into the marketplace. According to one implementation, lead scoring is used in the pricing algorithm for setting the price of the third party leads.

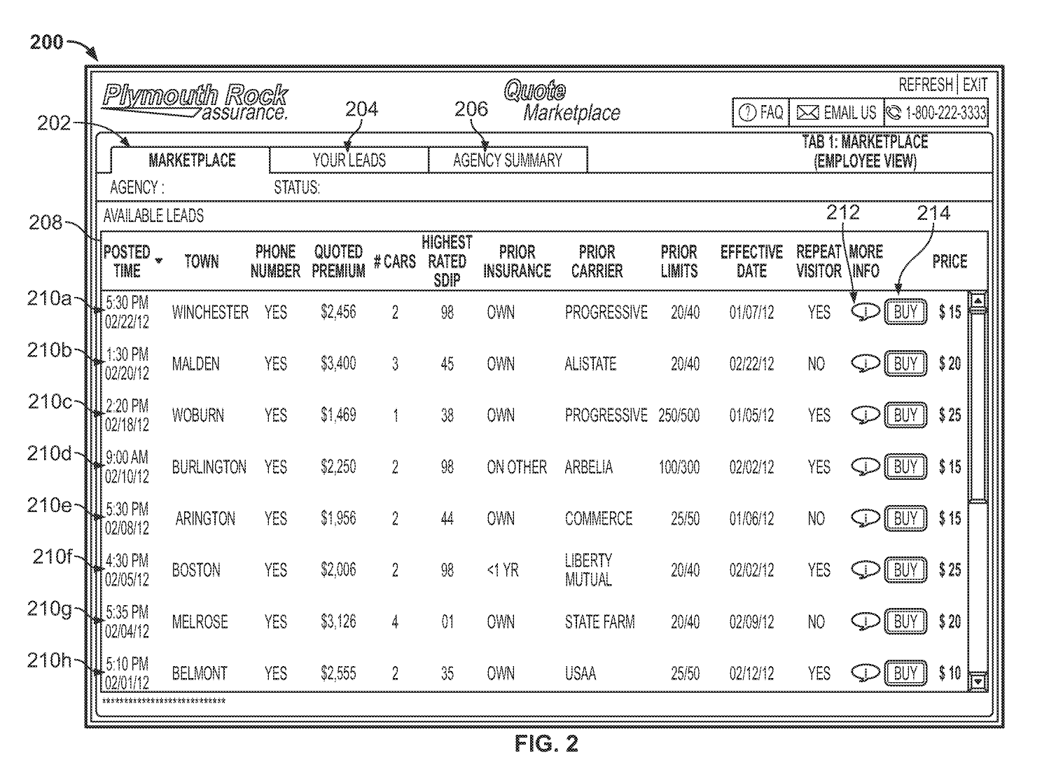

FIG. 2 shows an example webpage 200 displaying an online marketplace of leads. The marketplace shown on the webpage 200 is available to insurance agents, and represents a list a leads generated from website users who entered personal information on an insurance query website, but did not purchase insurance. The webpage 200 includes three tabs: a “Marketplace” tab 202, a “Your Leads” tab 204, and an “Agency Summary” tab 206. As shown on the webpage 200, the “Marketplace” tab 202 is currently selected. The marketplace of leads is displayed as a table 208 with each row 210a-210h providing information about a particular lead. As indicated at the top of each column, for each lead a limited amount of information is presented to the agent in the online marketplace. In the illustrative application shown on the webpage 200, for each lead, the information provided includes the time the lead was posted, the city or town where the lead resides, information indicating whether the lead provided a phone number, the premium that was quoted to the lead, the number of cars the lead owns, whether the lead had prior insurance and who the prior insurance company was, whether the lead is a repeat visitor, and the price for purchasing the lead. Each row also includes a button 212 for more information about the lead. If the agent selects the button 212, more information about the lead is provided. In other implementations, the table 208 includes a column indicating the source of the lead, as discussed in greater detail below.

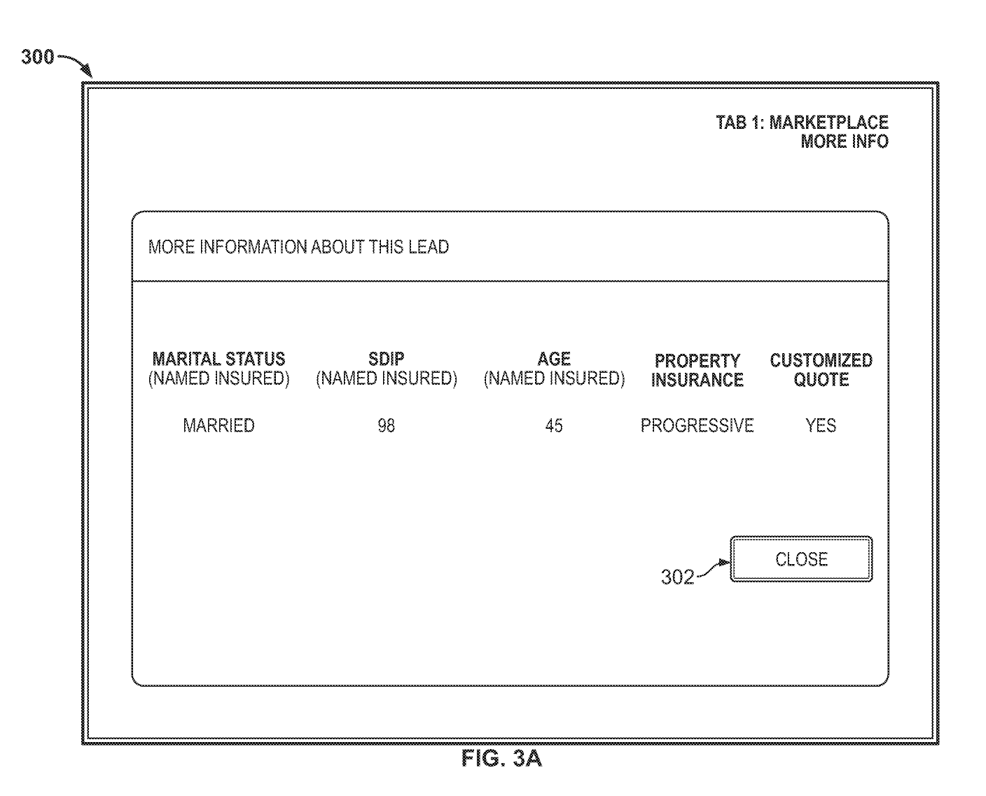

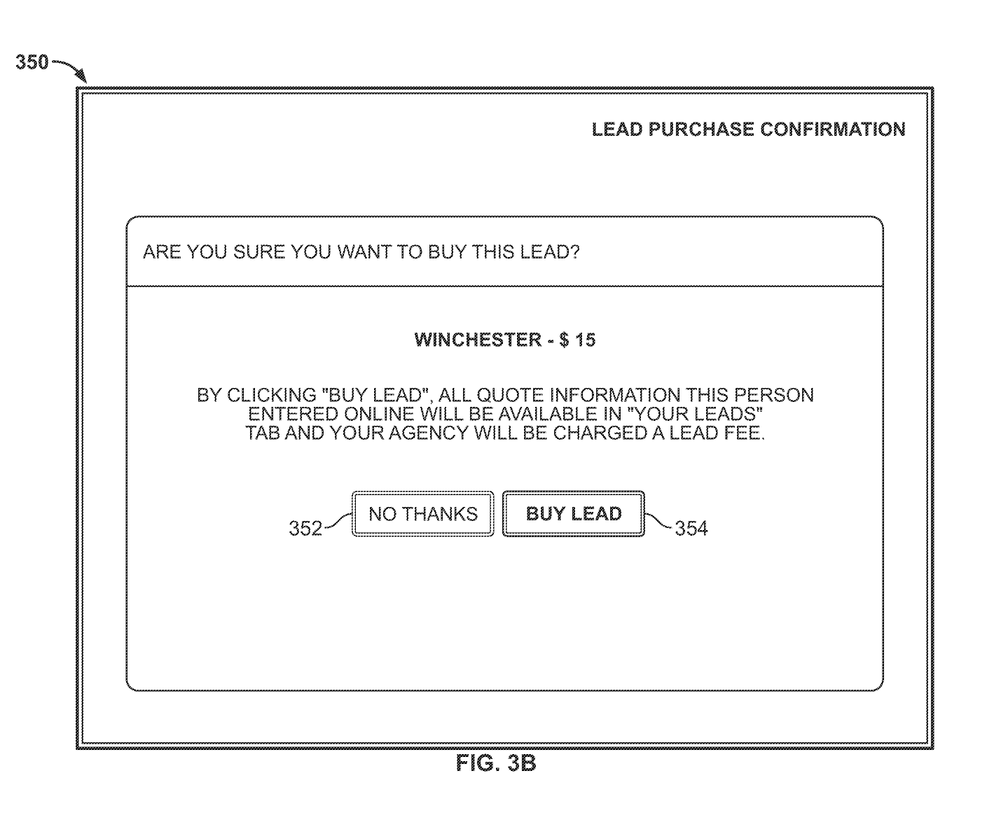

The additional information that may be available when an agent selects the button 212 may include the marital status of the lead, the SDIP (Safe Driver Insurance Plan) rating of the driver (which indicates how many points the driver has on their license), the age of the lead, the property insurance company used by the lead and whether a customized quote was provided to the lead. Additional information may also be displayed, depending on what information the lead provided to the website. FIG. 3 shows an example of a webpage 300, which is displayed as a pop-up window in front of the webpage 200, and includes more information about a selected lead. The webpage 300 also includes a close button 302 which may be selected by the agent to close the window of the webpage 300 and return for the marketplace webpage 200. After viewing the additional information provided in the webpage 300, the agent may choose to purchase the lead on the webpage 200 in FIG. 2, or the agent may view additional information about other leads to determine whether to purchase a lead.

The row of information included for each lead in FIG. 2 includes a “Buy” button, such as the “Buy” button 214 for the first lead 210 in the table 208. In some implementations, the row includes a “buy” link instead of a button. The agent viewing the marketplace may select the “Buy” button 214 to purchase the first lead 210. When an agent selects the “buy” button a lead purchase confirmation webpage is displayed. FIG. 3B shows an example of a webpage 350 for confirming a lead purchase request for the first lead 210 in the table 208. As shown on the webpage 350 in FIG. 3B, the lead purchase confirmation page 350 asks the agent if they are sure they would like to purchase the lead. It also includes basic information about the lead—the city or town the lead is from and the cost of the lead. The agent has the option of selecting the “No thanks” button 352 to return to the marketplace of leads on the webpage 200, or to select the “Buy lead” button 354 and purchase the lead. If the agent selects the “Buy lead” button 354 and purchases the first lead 210, the first lead 210 is removed from the table 208, and from the marketplace of leads shown on the webpage 200 of FIG. 2. After removal, no other agents or users looking at the marketplace of leads on the webpage 200 will be able to purchase the lead shown in the first row of the table 208, and the table 208 will be updated such that the first lead 210 is no longer displayed to any other users.

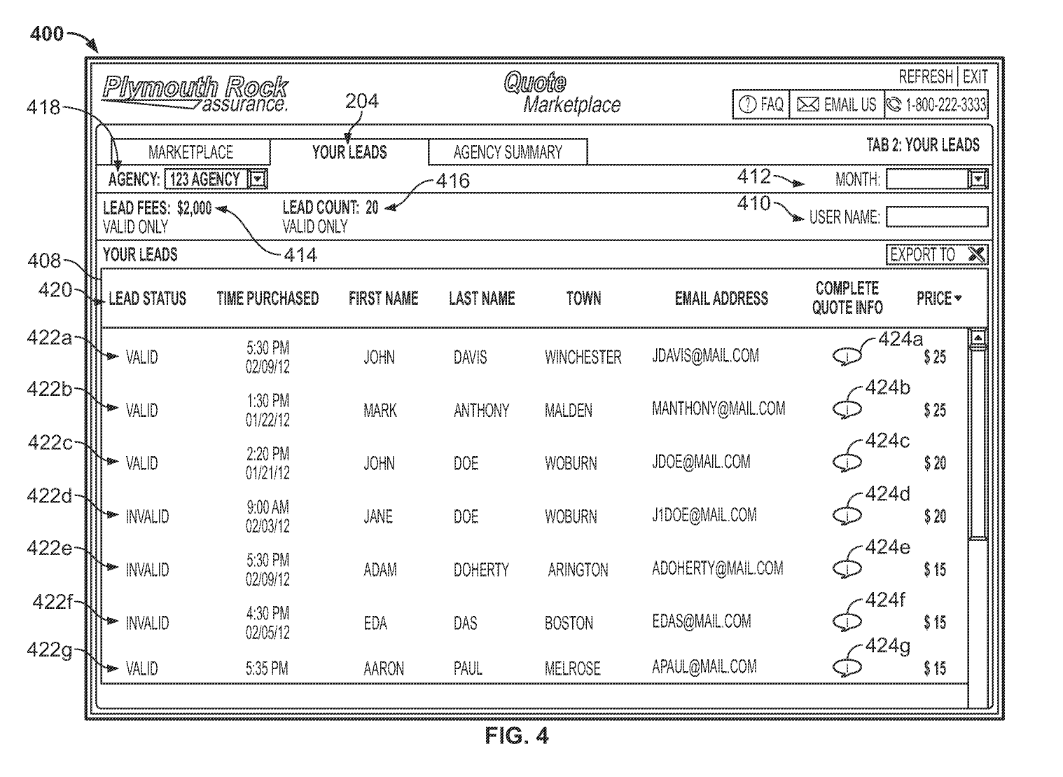

As discussed above, at the top of the webpage 200, there are three tabs, the “marketplace” tab 202, which is currently selected, the “your leads” tab 204 and the “agency summary” tab 206. FIG. 4 shows a webpage 400 having the same three tabs 202, 204 and 206 and with the “Your leads” tab 204 selected at the top of the page 400. The webpage 400 shows a table 408 of leads purchased by an agent. In one illustrative application, the webpage 400 is displayed to the agent who purchased the leads. The agent's name is shown in the “user name” box 410 on the right side of the webpage 400 above the lead table 408, and the agent's agency is displayed in the “Agency” box 418 on the left side of the webpage 400. Above the agent's name is a drop down box 412 in which the user can select the month and year. When the user selects a month and year from the drop down box 412, the table 408 of leads is updated to show all the leads purchased during the month and year selected. The left hand side of the page 400 above the table 408 of leads shows a summary of the table 408, including the number of leads 416 and the total lead fees 414. In one illustrative application, the number of leads 416 and the total lead fees 414 is updated when the month and year selected in the drop down box 412 is changed, such that the number of leads 416 and the total lead fees 414 reflect the totals for the selected month and year.

The lead table 408 includes a header row 420, and multiple lead rows 422a-422g. Each lead row 422a-422g shows some information about each purchased lead. In various examples, other information about each lead may be included in the table. For example, the lead table 408 may include a column indicating the source of each lead. For complete information about a lead, there is an information button 424a-424g in each lead row 422a-422g. When a user selects an information button 424a-424g, the complete lead information for the corresponding lead is displayed. The complete lead information may appear in a pop up window, on a separate webpage, or exportable to the agent's comparative rater. The left hand column of the table 408 shows the lead status for each lead. As shown in the table 408, leads 422a-422c and 422g are listed as valid while leads 422d-422f are listed as invalid. In certain implementations, an agent may set the status of a lead after the agent has purchased the lead. For example, if the lead is invalid, then the agent may change the status of a lead to invalid and request a refund for the lead price as discussed further below. A lead may be invalid if, for example, the lead phone number is incorrect or the email does not work.

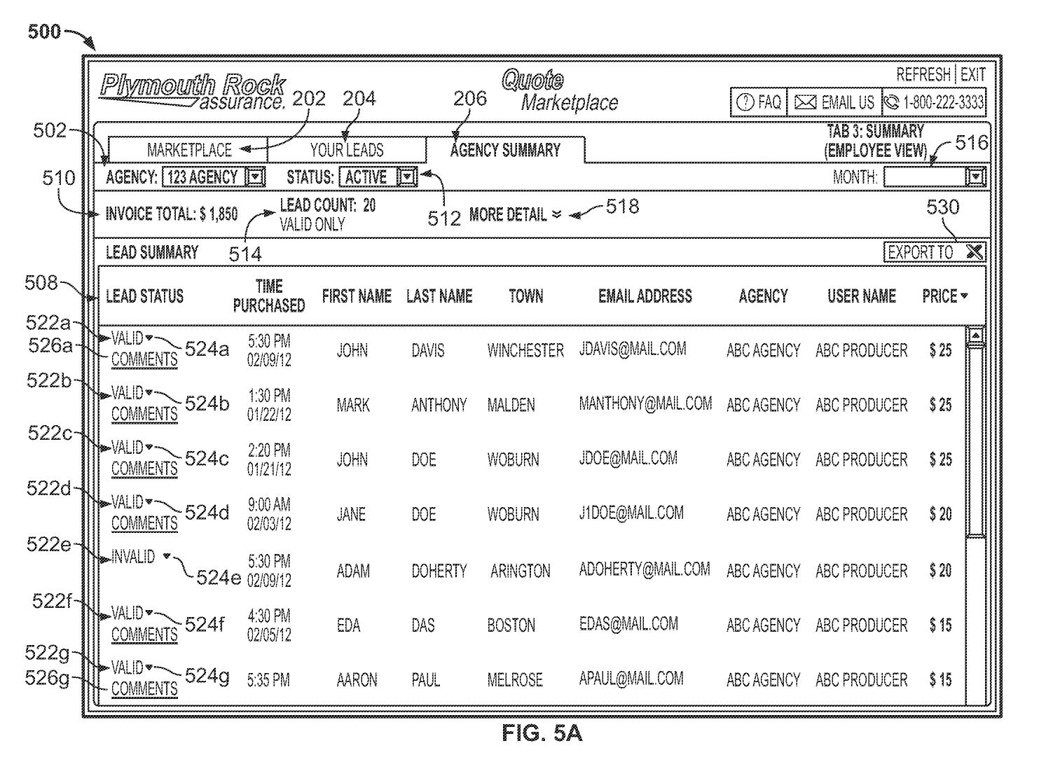

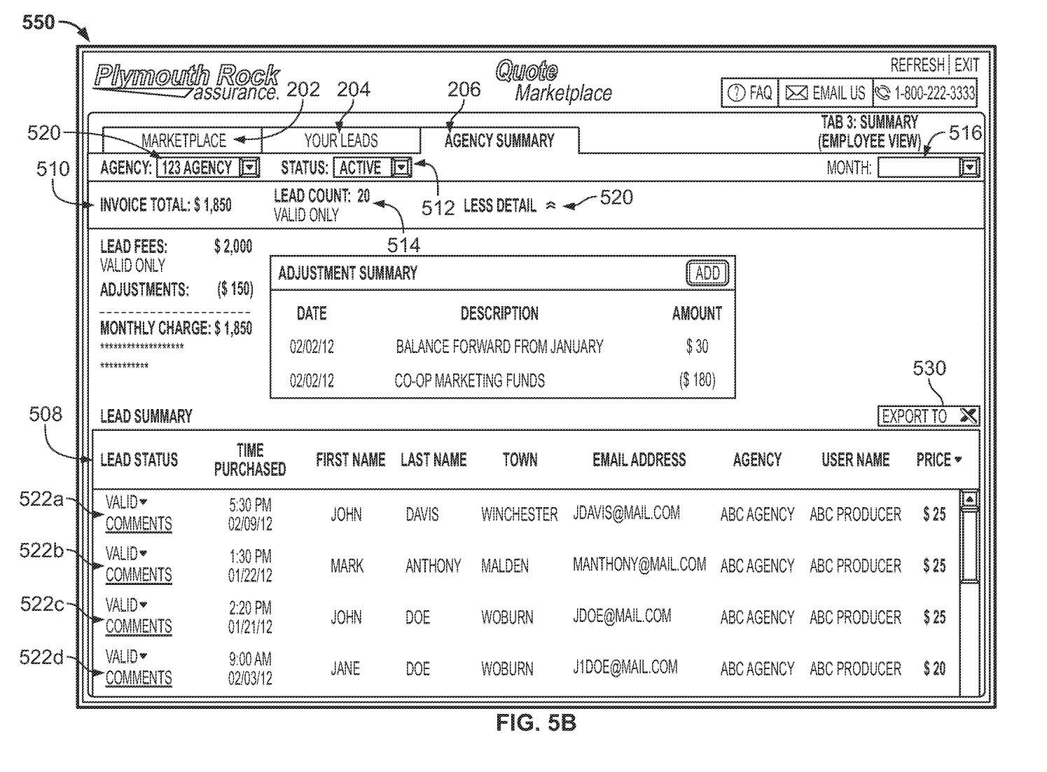

A list of leads purchased collectively by all agents in a given agency is displayed on the “Agency summary” tab 206 of the webpage 500, as shown in FIG. 5A. The webpage 500 shows a table 508 listing a summary of leads 522a-522g purchased by a particular agency. This may include leads purchased by multiple different agents who all work for the same agency. The agency can be selected by the user using the “Agency” drop down box 502. According to some applications, authorized agency representatives can use can use the webpage 500 to view an aggregate reporting of all leads purchased by its agents or employees. Webpage 500 includes a “Status” drop down box 512 for selecting the status of the leads to display, and it displays the total invoice 510 due, and the lead count 514. In the illustrative example, the lead count 514 shows only valid leads. The webpage 500 also shows a summary of the active leads in the lead table 508, which includes both valid and invalid leads. The lead table 508 is similar to the lead table 408 discussed above with respect to FIG. 4, with each column listing specific information about each lead. In other implementations, the lead table 508 includes a column indicating the source of each lead. The webpage 500 includes an invoice total 510, and can serve as an invoice for the agency.

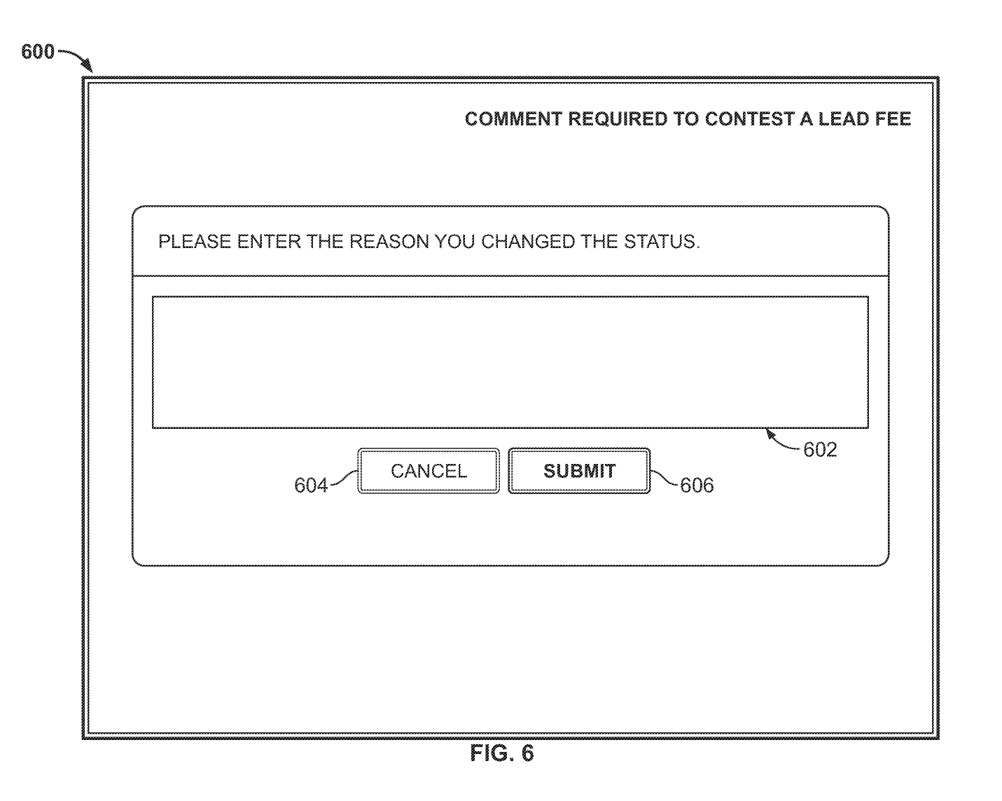

The webpage 500 allows a user to dispute the validity of a lead 522a-522g. In particular, the user viewing the webpage 500 can change the status of a lead 522a-522g using the arrow 524a-524g to the left of the word “valid” or “invalid” in the “lead status” cell for each respective lead 522a-522g. A user can also click on the “comments” button 526a-536g underneath the lead status to add comments regarding why the user is changing the status. FIG. 6 shows an example of a webpage 600, including a text edit box for submitting comments regarding the status of a lead. The webpage 600 shown in FIG. 6 is displayed when a user clicks the “comments” button 526a-526g in the webpage 500. The webpage 600 includes a text edit box 602 where a user can enter the reason for changing the status of a lead. The user may indicate, for example, that the phone number the lead provided is incorrect, or the email provided by the lead is incorrect and that the user is unable to contact the lead. After the user enters text in the text edit box 602 the user can click the “submit” button 606 to submit the comment to the website. Alternatively, the user can click the “cancel” 604 to close the webpage 600 without submitting a comment.

Referring back to FIG. 5A, the webpage 500 includes a “more detail” button 516 shown at the top middle, next to the lead count. When a user selects the “more detail” button 518, more details about the invoice total are displayed, as shown in the webpage 550 in FIG. 5B. The webpage 550 shows an invoice total comprised of a total leads fee for valid leads minus adjustments, for a total monthly charge of $1850. An adjustment summary is also displayed, which shows the date of a transaction, a description of the transaction, and the amount of the transaction. As shown on the webpage 550, there are two entries on Feb. 2, 2012. The first entry is a balance forward from the January invoice for $30. The second entry is a credit for $180 from cooperative marketing funds. According to various implementations, a user may select a different month in the drop down box 516 to see the invoice for that month and can select the “less detail” button 520 in FIG. 5B to decrease the detailed invoice display for the selected month.

According to the illustrative application, the webpage 500 also includes an “Export to Excel” button 530, which, when selected, exports the table shown in webpage 500 to an Excel spreadsheet. A user may choose to export the table on a webpage to an Excel spreadsheet in order to perform further calculations on the data, or to save personal records of the data.

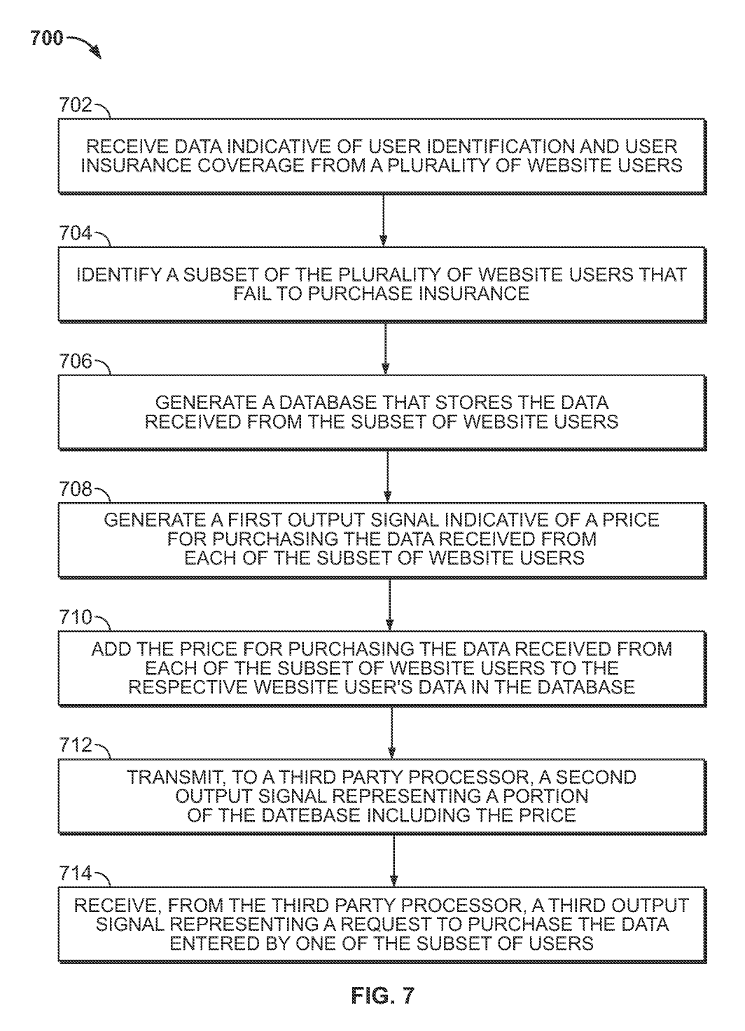

FIG. 7 is a flowchart of a method 700 for providing a web-based marketplace for distributing leads to a network of agents. At step 702, data indicative of user identification and required user insurance coverage is received from a plurality of website users. The data may be received at an insurance quote server through a website fillable form. Of the plurality of users who provide the information, some of the users may choose to purchase insurance through the website. However, a subset of the plurality fail to purchase insurance. At step 704, the subset who fail to purchase insurance are identified. At step 706, a database is generated to store the data received from the subset of users who failed to purchase insurance. In some implementations, the subset of users who fail to purchase insurance is further filtered to include only users who have provided a selected quantity and quality of information. For example, users who fail to provide any contact information are filtered out, and not included in the database. In other examples, the filter may use other criteria to determine which users to include in the database.

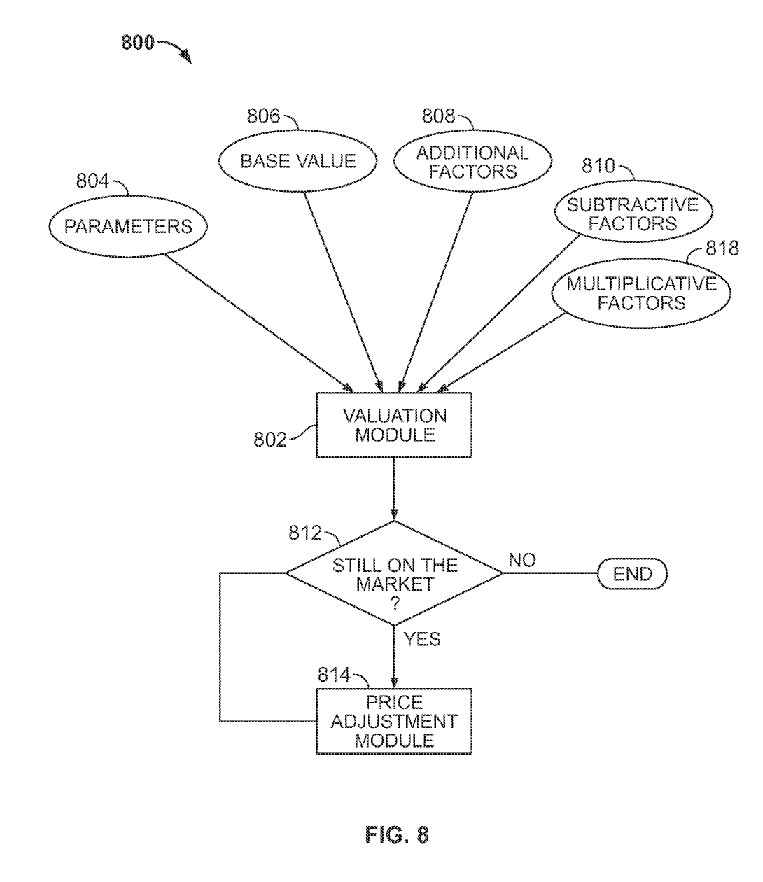

At step 708, a first output signal is generated for each of the subset of website users by a processor at the insurance quote server. The first output signal is indicative of a price for purchasing the data received from each of the subset of website users. The price is based on the information received from the user, and may be based on both the quantity of information provided by the user and the quality of the information. In one implementation, each lead is given a total point value based on the information provided by the user, and the initial lead price is based on the total point value. In this implementation, each element of data is given a point value, with some data worth more points than other data. If a data element is provided, the number of points corresponding to point value of the data is added to the total point value for the lead. In one example, the point value for a user's phone number is greater than the point value for the user's street address. In another example, the point value for a phone number is greater than the point value for the user's email address. Generally, the more valuable the data is to the agent, the greater the point value. Since calling a user on the phone is more likely to result in a sale than sending the user an email or regular mail correspondence, a phone number is worth more points than a street address or an email address. The pricing of leads is discussed in greater detail below with respect to FIG. 8.

At step 710, the price for purchasing the data received from each of the subset of website users is added to the respective website user's data in the database. At step 712, a second output signal is transmitted to a third party processor. The second output signal represents a portion of the data in the database and includes the lead price at which an agent can purchase the entire data set for each of the users whose data is included in the portion. At step 714, a third output signal is received from the third party processor. The third output signal represents a request to purchase a first website user's data. The first website user is one of the subset of website users.

In some implementations, for example, after an insurance agent buys the lead including the first website user and the first website user's data, the method 700 includes transmitting, from the first processor to the third party processor, a fourth output signal representing the first website user's data. Additionally, once a lead has been purchased, it is removed from the marketplace, and the method 700 includes removing, from the database, the data received from the first website user, and the price for purchasing the first website user's data.

According to certain implementations, each lead is priced individually. Thus, the price for purchasing the first website user's data may be different from the price for purchasing a second website user's data. The price may be generated based in part on one or more of a quantity of data provided by each respective website user, and the driving history of each respective website user. If is lead is not purchased within a certain time period, the price of the lead may be reduced. In various examples, the price of a lead may be reduced after the lead has been on the marketplace for about one hour, about two hours, about four hours, about six hours, about twelve hours, or about twenty-four hours. The price of the lead may be further reduced if it still is not purchased. In some applications, there is a minimum price for each lead, and the price may be periodically reduced until the minimum price is reached.

In some implementations, the method 700 includes acquiring a lead's driving record from the government motor vehicle registry. For example, a driving record may be downloaded from an online motor vehicle registry database. In one application, when a driving record is available, the lead's driving history is based at least in part on the driving record. Similarly, a vehicle record may be downloaded from an online motor vehicle registry database, and, when a vehicle record is available, the price for purchasing the lead's data is generated based in part on the vehicle information. In some implementations, the method 700 includes acquiring a lead's driving history or a vehicle's history or record from a non-governmental third party source. When a third party driving record and/or vehicle record is available, the price for purchasing the lead's data is generated based in part on the driver and/or vehicle information.

In some applications, the data received at the insurance policy server from each website user includes at least one of the town of residence, zip code, number of cars, driving record, phone number and email address of each of the subset of website users. In some implementations, a website user may request to be contacted by an insurance agent, and the method 700 includes receiving a second input signal indicative of a willingness to be contacted by an agent from the website user.

FIG. 8 is a block diagram of a system 800 for dynamically pricing leads, according to an illustrative embodiment. A valuation module 802 receives information from various sources and uses the information to generate a price for a lead. As shown in FIG. 8, the valuation module 802 receives a lead's parameters 804, a base value 806 for the lead, additive factors 808, subtractive factors 810, and multiplicative factors 818. The parameters 804 may include information such as driving record, prior insurance history, and number of cars. The base value 806 may be a predetermined value based on the type of insurance the lead is interested in purchasing. For example, if the lead is interested in purchasing the minimum required auto insurance, the base value may be $5.00. In another example, if the lead is interested in purchasing premium insurance, the base value may be $8.00. Additive factors 808 may include previous insurance coverage or a clean driving record. Subtractive factors 810 may include previous insurance claims or accidents. Multiplicative factors 818 may include the source of the lead, with each sources associated with a selected multiplicative number. In one illustrative application, information about a lead, such as driver or vehicle information, may be accessed from a Registry of Motor Vehicles (RMV) database. In this application, the insurance provider server accesses the RMV server and requests any information the RMV has in its database on the user, any other drivers who would be covered by the insurance plan, and the car or cars to be insured. The RMV provides its information to the insurance company server. The RMV's information on a driver may include the driver's driving record, including any history of tickets, warnings or accidents. The RMV's information on a vehicle may include any transactions involving the vehicle (inspection history), as well as an accident history of the vehicle.

After the valuation module 802 has determined a price, the price is added to the database for that lead. However, the valuation module 802 will periodically check to determine whether the lead is still on the market (decision box 812). If the lead is still on the market, it may indicate that the price the valuation module generated for the lead is too high, and the system 800 proceeds to the price adjustment module 814. The price adjustment module 814 determines how long the lead has been on the market, and may consider the amount of time the lead has been on the market during regular business hours. The price adjustment module 814 may decrease the price for the lead. The system 800 continues to periodically check if the lead is still on the market (at 812), and the lead may be price adjusted again at the price adjustment module 814.

In one implementation, for car insurance leads, each lead is given a base price of ten dollars. This is the initial lead price, which increases or decreases based on various factors. Below are various examples of how various factors may affect the lead price. Additional fees for the lead are added based on factors that indicate the likelihood that the lead will purchase an insurance policy, and the likely cost of the insurance policy coverage, which correlates with the insurance agent's commission. For example, if the lead is interested in insuring more than one car, a supplemental fee is added to the base price. For example, for two cars, five dollars is added to the base price, for three cars, eight dollars is added to the base price, for four cars, eleven dollars is added to the base price, for five cars, fourteen dollars is added to the base price, and for six cars, sixteen dollars is added to the base price. Another fee may be added (or an amount deducted) based on the lead's prior insurance history. For example, if the lead has previously held car insurance under the lead's own name, a two dollar fee may be added to the lead price. However, if the lead has previously owned a car without owning any insurance, four dollars may be deducted from the lead price. If the lead currently has car insurance, another fee may be added to the base price based on the amount of coverage of the lead's current policy, with higher coverage amounts resulting in a higher fee.

Another factor considered in determining the fee for a lead is the SDIP rating. A rating of 99 or 98 is considered very good. In one example, a four dollar fee is added to the base price for a lead with a SDIP rating of 99 and a two dollar fee is added to the base price for a lead with a SDIP rating of 98. A score of zero is considered fair, and no fee is added to the base price for a lead with a SDIP rating of zero. Similarly, if no SDIP rating is found for the lead, no fee is added to the base price. SDIP ratings between 01 and 45 are not considered good, and result in a reduction in the lead price. Thus, in various examples, a SDIP rating between 01-02 results in a one dollar reduction in the lead price, a SDIP rating between 03-06 results in a three dollar reduction in the lead price, SDIP rating between 07-10 results in a five dollar reduction in the lead price, SDIP rating between 11-20 results in a seven dollar reduction in the lead price, SDIP rating between 20-45 results in a ten dollar reduction in the lead price.

Another factor that may considered in determining the fee for a lead is whether the lead has property insurance. In one example, if the lead carries property insurance, a five dollar fee is added to the lead price. If the lead does not respond to the question regarding property insurance, or if the lead is not applicable for property insurance, no fee is added to the lead price, and no deduction is taken from the price. In another example, if the lead provides a valid phone number, a twelve dollar fee is added to the lead price. In a further example, a five dollar fee is added to the lead price if the lead is a repeat visitor to the insurance quote website.

According to one implementation, after the above factors, based on the profile of the lead, have been considered, the lead price is adjusted based on the source of the lead. For example, the source of the lead is considered “Premium” if, after viewing the website quote, the user selected “compare rates,” viewed the various insurance rates, and then did not buy insurance. However, if the user viewed the website quote but did not select “compare rates,” the source of the lead is considered “Standard.” In this example, the Premium source is considered more valuable because these users opted into the offer to receive comparison rates from an agent, and these users are considered more likely to purchase insurance through an agent. The Standard source is less valuable since these users did not begin the insurance purchasing process, but simply requested a quote, which could be for purely informational purposes. Thus, in one implementation, the price for a lead having a premium source is multiplied by 1 (i.e., it is unchanged), and the price for a lead having a standard source is multiplied by 0.2, thereby decreasing the price by eighty percent. According to one feature, the multiplication factor associated with each source is an assessment of the relative quality of the sources.

In various examples, different sources may be assigned different values, which may increase or decrease the price of the lead reflecting a likelihood of success in selling insurance to leads from each respective source. Other sources can be same quality (a multiplication factor of one), lower quality (a multiplication factor less than one) or better quality (a multiplication factor greater than one). In other implementations, a lead price charged by a third party may bypass the lead-price calculations formula and be posted on the marketplace at the price charge by the third party. In some implementations, the lead price charge by a third party is used in calculating a higher lead price for posting the marketplace.

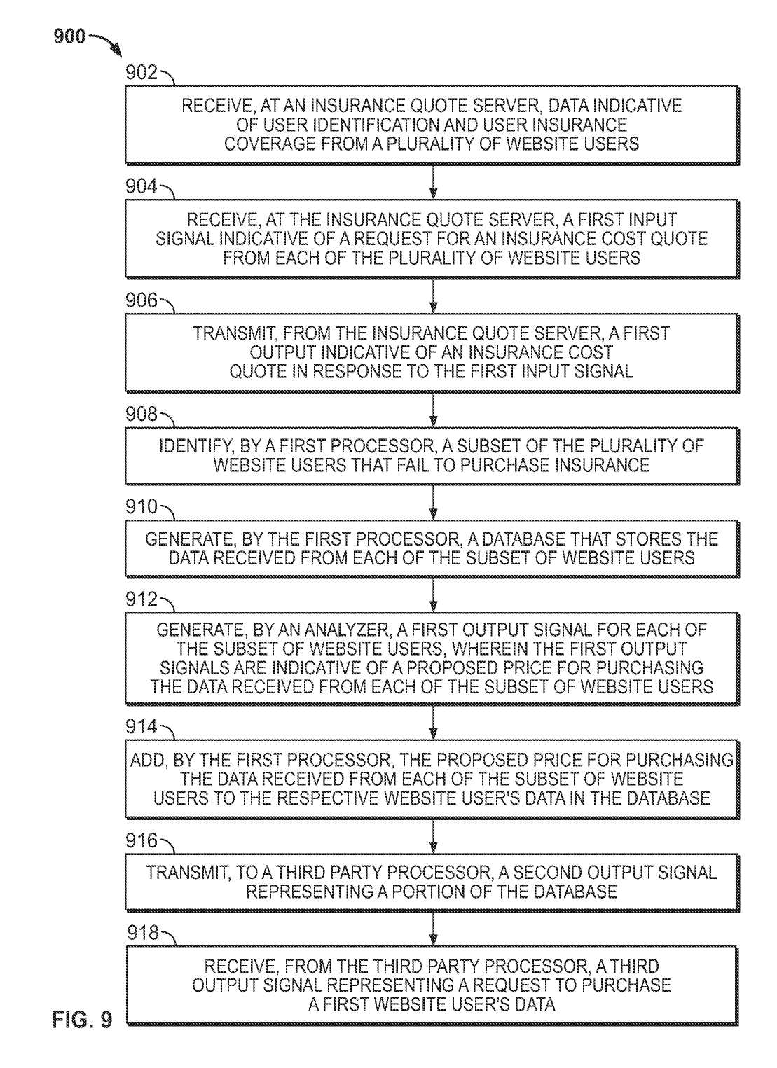

FIG. 9 is a flowchart of a method 900 for providing a web-based marketplace for distributing leads to a network of agents, according to one embodiment. At step 902, data indicative of user identification and user insurance coverage is received from a plurality of website users at an insurance quote server. At step 904, a first input signal indicative of a request for an insurance cost quote is received from each of the plurality of website users. At step 906, a first output indicative of an insurance cost quote is transmitted in response to the first input signal. At step 908, a subset of the plurality of website users that fail to purchase insurance is identified by a first processor. At step 910, the first processor generates a database that stores the data received from each of the subset of website users. At step 912, a first output signal is generated for each of the subset of website users, wherein the first output signals are indicative of a price for purchasing the data received from each of the subset of website users. At step 914, the price for purchasing the data received from each of the subset of website users is added to the respective website user's data in the database. At step 916, a second output signal representing a portion of the database is transmitted to a third party processor. At step 918, a third output signal is received from the third party processor, wherein the third output signal represents a request to purchase a first website user's data, wherein the first website user is one of the subset of website users.

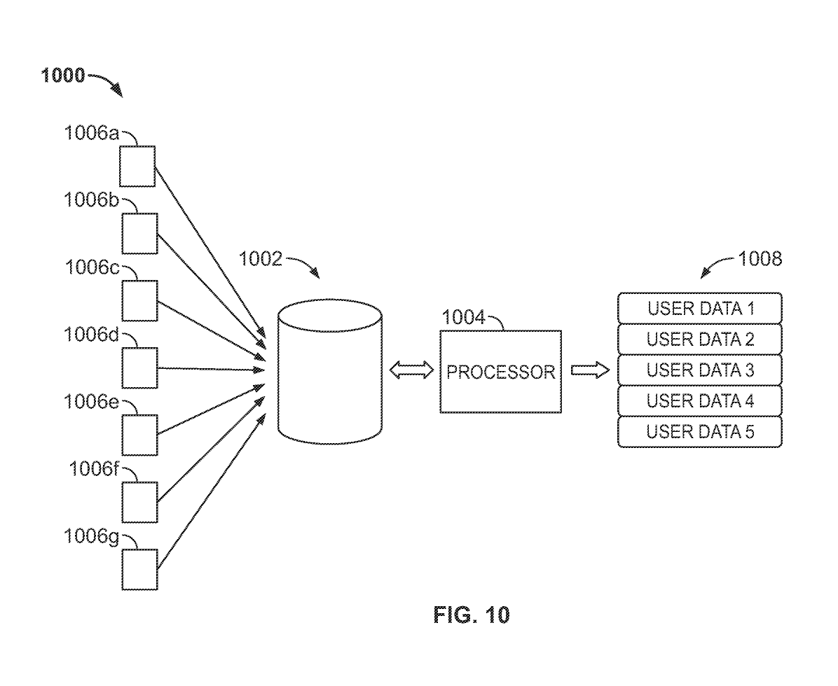

FIG. 10 is a block diagram of a system 1000 for providing a web-based marketplace for distributing leads to a network of agents, according to one embodiment. The system 1000 includes an insurance quote server 1002 for receiving information from a plurality of website users 1006a-1006g. A processor 1004 may analyze the data received by the website users 1006a-1006g. The processor 1004 may determine which website users 1006a-1006g fail to purchase insurance on the website, and generate a database 1008 including the subset of users who failed to purchase insurance. The processor 1004 generates a price for each user's data. The processor 1004 may include the valuation module 802 of FIG. 8, and may use the method 800 of FIG. 8 in determining the price of each user's data. A transceiver may be used to transmit the data in the database 1008 to a third party processor, and receive a request from the third party processor to purchase one or more users' data.

According to various implementations, insurance quote websites and webpages showing a marketplace of leads may vary from the websites depicted herein. For example, some of the information and/or buttons included on a depicted website may be excluded from an insurance quote website, and other information and/or buttons may be added.

Those skilled in the art will know or be able to ascertain using no more than routine experimentation, many equivalents to the embodiments and practices described herein. Examples of changes, substitutions, and alterations are ascertainable by one skilled in the art and could be made without departing from the scope of the information disclosed or taught herein. The disclosed features and subject matter may be implemented in any combination and sub combinations (including multiple dependent combinations and sub-combinations), with one or more other features described herein. The various features described or illustrated above or in the Figures, including any components thereof, may be combined or integrated into other systems. Moreover, certain features may be omitted or not implemented. All references cited herein are incorporated by reference in their entirety and made part of this application.

What we claim is:

1. A computer-implemented method of providing a web-based marketplace for distributing leads to a network of agents, comprising:
receiving, at an insurance quote server, data indicative of user identification and user insurance coverage from a plurality of website users;
receiving, at the insurance quote server, a first input signal indicative of a request for an insurance cost quote from each of the plurality of website users;
transmitting, from the insurance quote server, a first output indicative of an insurance cost quote in response to the first input signal;
identifying, by a first processor, a subset of the plurality of website users that fail to purchase insurance;
generating, by the first processor, a database that stores the data received from each of the subset of website users;
generating, by an analyzer, a first output signal for each of the subset of website users, wherein the first output signals are indicative of a price for purchasing the data received from each of the subset of website users;
adding, by the first processor, the price for purchasing the data received from each of the subset of website users to the respective website user's data in the database;
transmitting, to a third party processor, a second output signal representing a portion of the database;
receiving, from the third party processor, a third output signal representing a request to purchase a first website user's data, wherein the first website user is one of the subset of website users.

2. The method of claim 1, further comprising:
transmitting, from the first processor to the third party processor, a fourth output signal representing the first website user's data; and
removing, from the database, the data received from the first website user, and the price for purchasing the first website user's data.

3. The method of claim 1, wherein a first price for purchasing the first website user's data is different from a second price for purchasing a second website user's data.

4. The method of claim 3, wherein the price for purchasing the data received from each website user of the subset is generated based in part on a quantity of data provided by each respective website user.

5. The method of claim 4, further comprising updating the price for purchasing the second website user's data after the second website user's data has been on the marketplace for a predetermined period of time.

6. The method of claim 3, wherein the price for purchasing the data received from each website user of the subset is generated based in part on a driving history of each respective website user.

7. The method of claim 6, further comprising acquiring a driving record for each of the subset of website users from at least one of a government motor vehicle registry and a non-government third party, and wherein the driving history is based at least in part on the driving record.

8. The method of claim 7, wherein acquiring the driving record includes accessing an online copy of the driving record and downloading driving record data.

9. The method of claim 1, further comprising acquiring vehicle information for a vehicle owned by the first website user from at least one of a government motor vehicle registry and a non-government third party, and wherein the price for purchasing the first website user's data is generated based in part on the vehicle information.

10. The method of claim 1, further comprising receiving a second input signal indicative of a willingness to be contacted by an agent from each of the subset of the plurality of website users.

11. The method of claim 1, wherein the data received at the insurance policy server includes at least one of the town of residence, zip code, number of cars, driving record and phone number of each of the subset of website users.

12. A computer-implemented method of providing a web-based marketplace for distributing leads to a network of agents, comprising:
receiving, at an insurance quote server, data indicative of user identification and user insurance coverage from a plurality of website users;
identifying, by a first processor, a subset of the plurality of website users that fail to purchase insurance;
generating, by the first processor, a database that stores the data received from the subset of website users;
generating, by an analyzer, a first output signal indicative of a price for purchasing the data received from each of the subset of website users, wherein the price is based on a base value, parameters entered by each of the subset of users, additive factors for each of the subset of users, subtractive factors for each of the subset of users, and multiplicative factors for each of the subset of users;
adding, by the first processor, the price for purchasing the data received from each of the subset of website users to the respective website user's data in the database;
transmitting, to a third party processor, a second output signal representing a portion of the database including the price; and
receiving, from the third party processor, a third output signal representing a request to purchase a first website user's data, wherein the first website user is one of the subset of users.

13. The method of claim 12, further comprising:
transmitting, from the first processor to the third party processor, a fourth output signal representing the first website user's data; and
removing, from the database, the data received from the first website user, and the price for purchasing the first website user's data.

14. The method of claim 12, wherein a first price for purchasing the first website user's data is different from a second price for purchasing a second website user's data.

15. The method of claim 14, wherein the price for purchasing the data received from each website user of the subset is generated based in part on at least one of a quantity of data provided by each respective website user, and a driving history of each respective website user.

16. The method of claim 15, further comprising acquiring a driving record for each of the subset of website users from a government motor vehicle registry, and wherein the driving history is based at least in part on the driving record.

17. The method of claim 16, wherein acquiring the driving record includes accessing an online copy of the driving record and downloading driving record data.

18. The method of claim 12, further comprising acquiring vehicle information for a vehicle owned by the first website user from a government motor vehicle registry, and wherein the price for purchasing the first website user's data is generated based in part on the vehicle information.
